(19) United States
(12) Patent Application Publication
(10) Pub. No.: US 2021/0374725 A1
(43) Pub. Date: Dec. 2, 2021

(54) WALLET SERVER, WALLET SYSTEM, AND COMPUTER READABLE RECORDING MEDIUM

(71) Applicant: TOYOTA JIDOSHA KABUSHIKI KAISHA, Toyota-shi (JP)

(72) Inventors: Shintaro MATSUTANI, Kariya-shi (JP); Misato YOKOTA, Tokyo-to (JP); Yumiko OSAKI, Tokyo-to (JP); Atsushi YONEKI, Chigasaki-shi (JP); Kazunari TSUTSUMI, Tokyo-to (JP); Mitsunori ISODA, Tokyo-to (JP); Yuzo YAMADA, Nagoya-shi (JP)

(73) Assignee: TOYOTA JIDOSHA KABUSHIKI KAISHA, Toyota-shi (JP)

(21) Appl. No.: 17/332,124

(22) Filed: May 27, 2021

(30) Foreign Application Priority Data
Jun. 1, 2020 (JP) 2020-095734

(51) Int. Cl. G06Q 20/36; G06Q 20/02; G06Q 20/10; G06Q 40/02; G06Q 20/32

(52) U.S. Cl. CPC G06Q 20/3676; G06Q 20/02; G06Q 20/363; G06Q 40/02; G06Q 20/3223; G06Q 20/108

(57) ABSTRACT

A wallet server includes a processor including hardware, the processor being configured to remit electronic money collected at a predetermined rate based on a plurality of payment transaction methods registered in a first electronic wallet associated with a first user, to at least one of a second electronic wallet and a deposit account of a financial institution that are associated with a second user.

The present application claims priority to and incorporates by reference the entire contents of Japanese Patent Application No. 2020-095734 filed in Japan on Jun. 1, 2020.

### BACKGROUND

The present disclosure relates to a wallet server, a wallet system, and a computer readable recording medium. JP 2009-151692 A discloses an electronic money bank system to safely store electronic money in an electronic money bank so that a required amount of electronic money of a required type may be withdrawn when needed. In the configuration described in JP 2009-151692 A, electronic money that is pooled in the electronic money bank is transferred between banks as request and allocated to various kinds of electronic money.

### SUMMARY

There is a need for a wallet server, a wallet system, and a computer readable recording medium that are configured to increase the degree of freedom in remittance of electronic money between users.

According to one aspect of the present disclosure, there is provided a wallet server including a processor including hardware, the processor being configured to remit electronic money collected at a predetermined rate based on a plurality of payment transaction methods registered in a first electronic wallet associated with a first user, to at least one of a second electronic wallet and a deposit account of a financial institution that are associated with a second user.

### BRIEF DESCRIPTION OF THE DRAWINGS

FIG. 1 is a diagram illustrating a schematic configuration of a wallet system according to an embodiment;

FIG. 2 is a block diagram illustrating functional blocks of the wallet system according to the embodiment;

FIG. 3 is a diagram illustrating an example of remittance based on a plurality of payment transaction methods in an electronic wallet;

FIG. 4 is a flowchart illustrating a remittance control process;

FIG. 5 is a flowchart illustrating a regular remittance control process;

FIG. 6 is a diagram illustrating an example of deposit and allocation in which deposit from a bank account to an electronic wallet is allocated for a plurality of payment transaction methods;

FIG. 7 is a flowchart illustrating a deposit control process;

FIG. 8 is a flowchart illustrating a regular deposit control process; and

FIG. 9 is a diagram illustrating an example of a family wallet.

### DETAILED DESCRIPTION

A wallet server, a wallet system, and a computer readable recording medium storing a program according to an embodiment will be described below with reference to the drawings. Note that the present disclosure is not limited to the embodiments described below.

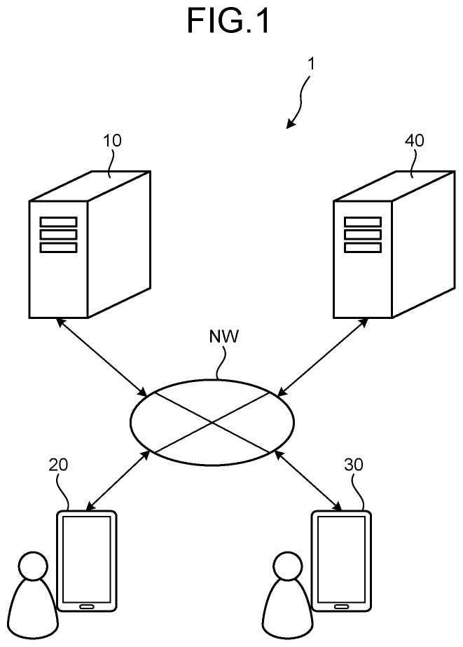

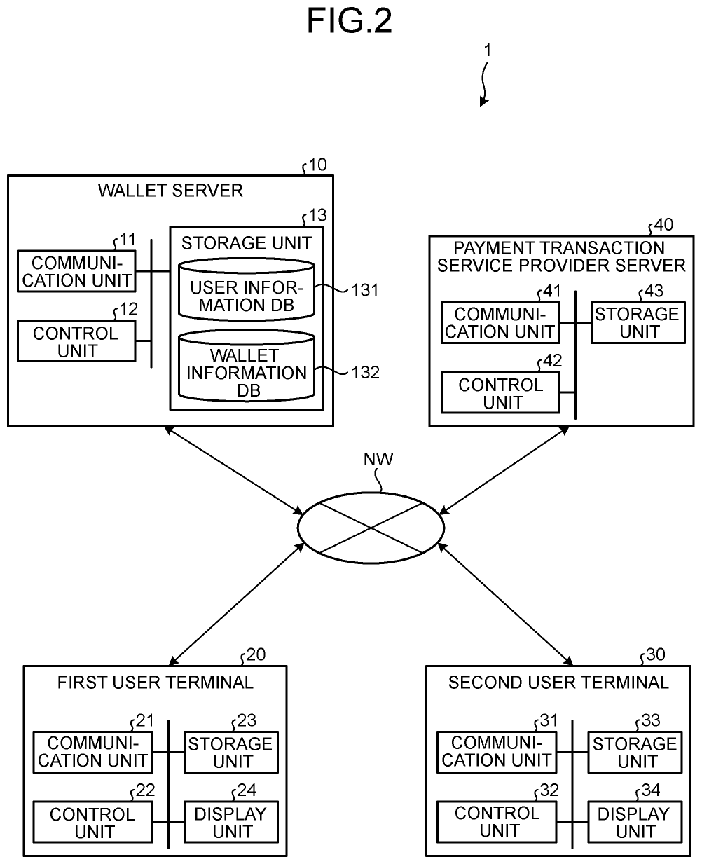

A configuration of a wallet system according to an embodiment will be described with reference to FIGS. 1 and 2. As illustrated in FIG. 1, a wallet system 1 according to the embodiment includes a wallet server 10, a first user terminal 20, a second user terminal 30, and a payment transaction service provider server 40.

In the wallet system 1, the wallet server 10, the first user terminal 20, the second user terminal 30, and the payment transaction service provider server 40 are configured to communicate with each other through a network NW. The network NW includes, for example, an Internet network, a mobile phone network, or the like.

The wallet server 10 is a server configured to integrally manage the wallet system 1 and is managed by an administrator of the wallet system 1. As illustrated in FIG. 2, the wallet server 10 includes a communication unit 11, a control unit 12, and a storage unit 13.

The communication unit 11 includes, for example, a local area network (LAN) interface board, a wireless communication circuit for wireless communication, and the like. The communication unit 11 is connected to the network NW such as the Internet being a public communication network. Then, the communication unit 11 is connected to the network NW to communicate with the first user terminal 20, the second user terminal 30, and the payment transaction service provider server 40.

The control unit 12 includes a processor and a memory. The processor includes a central processing unit (CPU), a digital signal processor (DSP), a field-programmable gate array (FPGA), and the like. The memory is a main storage unit and includes a random access memory (RAM), a read only memory (ROM), and the like. The control unit 12 loads a program stored in the storage unit 13 into a work area of the memory (main storage unit) and executes the program to control component units and the like through the execution of the program, thus, achieving a function satisfying a predetermined purpose.

The storage unit 13 includes a recording medium such as an erasable programmable ROM (EPROM), hard disk drive (HDD), removable medium, or the like. Examples of the removable medium include a universal serial bus (USB) memory and disc recording mediums such as a compact disc (CD), a digital versatile disc (DVD), and a Blu-ray (registered trademark) disc (BD). The storage unit 13 is configured to store an operating system (OS), various programs, various tables, various databases (DBs), and the like. The storage unit 13 includes a user information database 131 and a wallet information database 132.

The user information database 131 stores information about a user who uses the wallet system 1 (hereinafter, referred to as “user information”). Examples of the user information include, for example, an ID, password, name, contact information (e.g., address, telephone number, email address, etc.), registration history, information about payment means registered as deposit means, information about payment means registered as payment transaction means, password used upon payment transaction, and the like of a user who has registered to use the wallet system. Note that the user ID and password of the user information are used for authentication processing such as login to the wallet server 10.

The wallet information database 132 stores information about an electronic wallet of the wallet system 1 (hereinafter, referred to as “wallet information”). Examples of the wallet information include a user ID, the balance of electronic money, an electronic money deposit history, an electronic money usage history, and the like. In addition, the wallet information database 132 stores information about a payment transaction in the wallet system (hereinafter, referred to as “payment transaction information”). Examples of the payment transaction information include a user ID, payment transaction means used for payment transaction (e.g., electronic money payment, scan payment, code payment, etc.), a payment transaction history, and the like. Note that electronic money payment transaction is contactless payment transaction.

For example, an electronic wallet associated with a first user who owns the first user terminal 20 is a first electronic wallet. Wallet information about this first electronic wallet is stored in the wallet information database 132. Furthermore, an electronic wallet associated with a second user who owns the second user terminal 30 is a second electronic wallet. Wallet information about this second electronic wallet is stored in the wallet information database 132. The wallet system 1 is configured so that electronic money is remitted from the first electronic wallet associated with the first user to the second electronic wallet associated with the second user.

Furthermore, the storage unit 13 stores setting information for each electronic wallet. The setting information includes an execution condition for regular remittance from an electronic wallet, an execution condition for remittance and deposit of electronic money in an electronic wallet, or the like. In addition, the setting information includes information about a remittance amount in regular remittance, information about a combination of a plurality of payment transaction methods used in the remittance, and information about a rate of electronic money to be collected based on a plurality of payment transaction methods. Furthermore, the setting information includes information about a deposit amount in regular deposit, information about a combination of a plurality of payment transaction methods that is a deposit target in the deposit, and information about a deposit rate to the plurality of payment transaction methods.

The first user terminal 20 is a computer terminal that is owned by the first user. An example of the first user terminal 20 includes a smartphone, a mobile phone, a tablet terminal, a wearable computer, a personal computer, or the like owned by the user.

The first user terminal 20 includes a communication unit 21, a control unit 22, a storage unit 23, and a display unit 24. The communication unit 21, control unit 22, and storage unit 23 included in the first user terminal 20 are physically similar to the communication unit 11, control unit 12, and storage unit 13 included in the wallet server 10. The first user terminal 20 may use any terminal as long as the terminal is configured to transmit and receive information to and from the wallet server 10 via the network NW.

The control unit 22 functions as a display control unit, a deposit means registration unit, a payment transaction means registration unit, a deposit processing unit, and a payment transaction processing unit by executing programs stored in the storage unit 23.

When the control unit 22 functions as the display control unit, the control unit 22 controls a display content on the display unit 24. The control unit 22 displays various screens on the display unit 24 based on the operation by the first user (touch operation, flick operation, etc.). Examples of display screens include a login screen for login to the wallet system 1, a payment transaction screen for payment transaction by scan payment or the like, a transaction history screen showing a list of transaction history such as payment transaction, a detailed payment history screen showing details of payment history, a deposit screen for deposit of electronic money in the electronic wallet, and the like. Furthermore, the control unit 22 transitions the screens based on the operation by the first user.

Furthermore, when the control unit 22 functions as the deposit means registration unit, the control unit 22 registers deposit means to deposit electronic money. The deposit means represents means to deposit electronic money in an electronic wallet that is a virtual transaction account. The deposit means includes, of the payment means, a bank account and a credit card. Registration of the bank account and the credit card as the deposit means makes it possible to deposit electronic money in the electronic wallet. In addition, the payment means represents means as payment funds for payment transaction. The payment means includes a bank account, a credit card, and the balance of electronic money in the electronic wallets. Each credit card is associated with a bank account, and an amount of payment by each credit card is withdrawn later, from a corresponding bank account.

The control unit 22 transmits a deposit means registration request for registering a plurality of different payment means operated by a plurality of service providers, as the deposit means to the electronic wallet, to the wallet server 10. When receiving the deposit means registration request from the first user terminal 20, the control unit 12 of the wallet server 10 stores the payment means included in the deposit means registration request, as the user information, in the user information database 131 of the storage unit 13. Therefore, the payment means is registered in the user information database 131, as the deposit means.

Furthermore, when the control unit 22 functions as the payment transaction means registration unit, the control unit 22 registers the payment means that is registered as the deposit means, also as the payment transaction means. The payment transaction means represents a method of payment transaction using the payment means. Examples of the payment transaction means include scan payment, electronic money payment, and code payment. The scan payment, the electronic money payment, and the code payment are all payment transaction means using the balance of electronic money in the electronic wallet.

For example, the control unit 22 transmits a payment transaction request for payment transaction with electronic money deposited in the electronic wallet by using any of a plurality of preset payment transaction means (electronic money payment, scan payment, code payment), to the wallet server 10 or a store terminal. At that time, in the electronic money payment, the control unit 22 transmits the payment transaction request to the store terminal through a short-range wireless communication unit. Furthermore, the scan payment represents a payment transaction made by reading a bar code or QR code (registered trademark) posted at the store with a camera or the like of the first user terminal 20. In addition, in the code payment, the control unit 22 transmits the payment transaction request to the store terminal by causing a reading unit such as a code reader of the store terminal to read a bar code or QR code (registered trademark) displayed on the first user terminal 20.

Furthermore, when the control unit 22 functions as the deposit processing unit, the control unit 22 deposits electronic money in the electronic wallet. The control unit 22 transmits a deposit request for deposit of electronic money in the electronic wallet by the payment means registered as the deposit means, to the wallet server 10. When receiving the deposit request from the first user terminal 20, the control unit 12 of the wallet server 10 increases the balance of electronic money in the electronic wallet, based on the deposit amount information included in the deposit request. In other words, the control unit 12 updates the wallet information stored in the storage unit 13, according to an increase in the balance of electronic money in the electronic wallet.

Furthermore, when the control unit 22 functions as the payment transaction processing unit, the control unit 22 makes a payment transaction by the payment means. For example, in scan payment, the control unit 22 transmits the payment request (payment transaction request) to the wallet server 10 by reading a QR code (registered trademark) or the like posted in a store with the camera or the like of the first user terminal 20.

Note that when the control unit 22 functions as the payment transaction processing unit, the control unit 22 can also make a payment transaction by the payment means (e.g., bank account, credit card) other than the balance of electronic money in the electronic wallet. For example, when the deposit means registration request is transmitted from the first user terminal 20 to the wallet server 10, the control unit 22 transmits a registration request for registration of the payment means included in the deposit means registration request as the payment transaction means, to the wallet server 10. In other words, when the control unit 22 registers, as the deposit means, certain payment means (e.g., a bank account of an X bank) on the wallet server 10, this payment means (the bank account of the X bank) is automatically registered also as the payment transaction means. “Register the payment means as the payment transaction means” represents that the payment means is in a payment transaction state as a payment source. In other words, it means that scan payment is possible using the bank account of the X Bank as the payment source. When receiving the registration request from the first user terminal 20, the control unit 12 of the wallet server 10 stores, as the user information, the payment means included in the registration request, in the user information database 131. Thus, the payment means is registered as the payment transaction means. Then, the control unit 22 transmits the payment request for payment through the bank account or credit card by using any of the plurality of payment transaction means, to the wallet server 10. When receiving the payment request (payment transaction request) from the first user terminal 20, the control unit 12 transmits payment transaction amount information included in the payment request, to the payment transaction service provider server 40. Then, payment transaction processing is performed by information communication between the wallet server 10 and the payment transaction service provider server 40.

The storage unit 23 stores various screen data that the control unit 22 causes the display unit 24 to display. In addition, the storage unit 23 temporarily stores, if necessary, the user information, wallet information, and the like.

The display unit 24 includes, for example, a touch panel display and has an input function of receiving an operation by a user's finger, pen, or the like and a display function of displaying various information based on control of the control unit 22.

The second user terminal 30 is a computer terminal that is owned by the second user. An example of the second user terminal 30 includes a smartphone, a mobile phone, a tablet terminal, a wearable computer, a personal computer, or the like owned by the second user.

The second user terminal 30 includes a communication unit 31, a control unit 32, a storage unit 33, and a display unit 34. The communication unit 31, the control unit 32, the storage unit 33, and the display unit 34 included in the second user terminal 30 are physically similar to the communication unit 21, the control unit 22, the storage unit 33, and the display unit 24 included in the first user terminal 20. The second user terminal 30 may use any terminal as long as the terminal is a mobile terminal configured to transmit and receive information to and from the wallet server 10 via the network NW.

The payment transaction service provider server 40 is a server for managing a user's account and credit card, and is provided in a financial institution (e.g., bank, credit bank, credit union, workers' credit union, etc.) and a credit card company. The payment transaction service provider server 40 includes a communication unit 41, a control unit 42, and a storage unit 43. The communication unit 41, the control unit 42, and the storage unit 43 included in the payment transaction service provider server 40 are physically similar to the communication unit 11, control unit 12, and storage unit 13 included in the wallet server 10.

The storage unit 43 stores account information and credit card information for each user of the wallet system 1. Examples of the account information include the name, account number, account balance, deposit/withdrawal history, and the like of a user. Examples of the credit card information include the name, credit card number, credit card expiration date, usage limit, card usage history, and the like of a user.

As described above, in the wallet system 1, the respective users own the first user terminal 20 and the second user terminal 30. Then, in the wallet server 10 the electronic wallets are registered for the respective users. In an electronic wallet, three payment transaction methods, such as, “A Pay”, “B Pay”, and “C Pay”, are registered as a plurality of different payment transaction methods. The “A Pay”, “B Pay”, and “C Pay” may be any of the payment transaction by bank account, payment transaction by credit card, and payment transaction by electronic money. The payment transaction by bank account is a payment transaction method in which the amount of payment transaction is withdrawn directly from a bank account. The bank account is associated with a credit card, and an amount of payment by the credit card is withdrawn from the bank account later. In addition, the electronic wallet is associated with the deposit means such as a bank account and a credit card that are means for deposition of electronic money, and it is possible to deposit electronic money. Furthermore, when the electronic money is of prepaid type that requires deposit of cash money or the like in advance, the electronic money may not be necessarily associated with the deposit means such as a bank account and a credit card.

In the wallet system 1 configured as described above, the plurality of payment transaction methods registered in the electronic wallet is configured to remit electronic money collected based on the plurality of payment transaction methods as one remittance process.

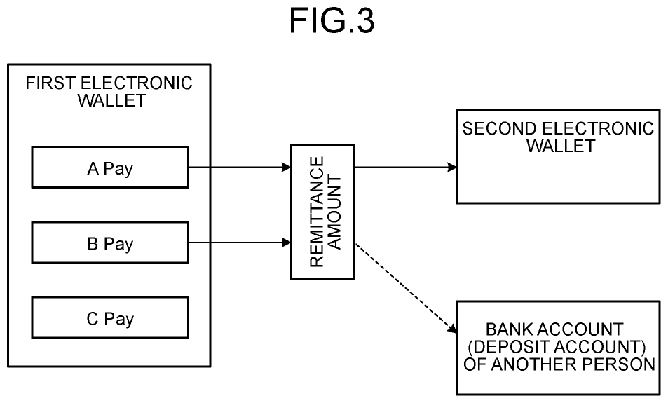

FIG. 3 is a diagram illustrating an example of remittance based on the plurality of payment transaction methods in an electronic wallet.

A description will be made of remittance by the “A Pay” and “B Pay” registered in the first electronic wallet to an electronic wallet of another person. Electronic money is collected at a predetermined rate based on the “A Pay” and “B Pay” so that the amount of the electronic money meets a remittance amount. Then, the electronic money collected based on the plurality of payment transaction methods is remitted as the remittance amount, to the second electronic wallet that is an electronic wallet as a remittance destination.

In the remittance, it is also possible to make a remittance to a bank account of the another person, instead of the second electronic wallet. This bank account is preferably an account of a financial institution.

Furthermore, it is also possible to make a remittance to both of the second electronic wallet and the bank account. In this case, the remittance is made to the second electronic wallet and the bank account at a predetermined ratio.

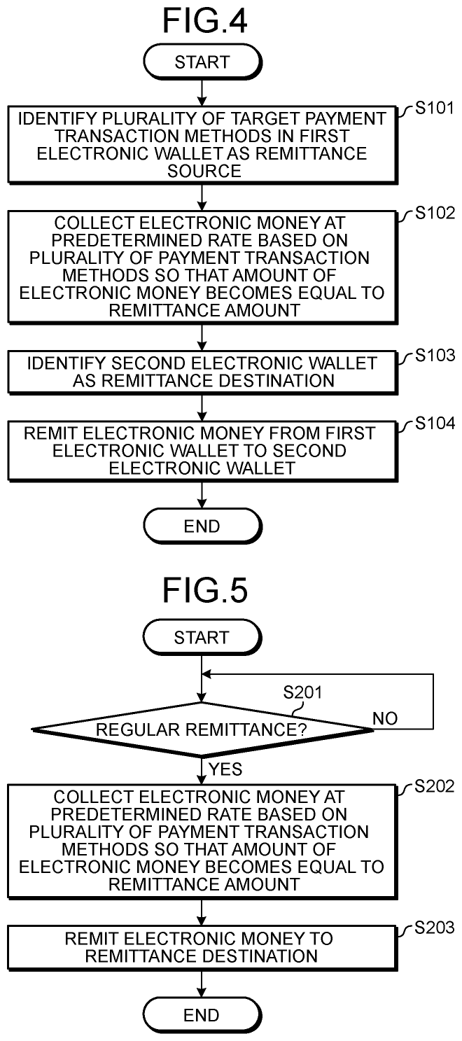

FIG. 4 is a flowchart illustrating a remittance control process. The control illustrated in FIG. 4 is performed by the wallet server 10.

When remitting electronic money between users, the wallet server 10 identifies a plurality of target payment transaction methods, in the first electronic wallet of the first user that is a remittance source (Step S101). In Step S101, payment transaction methods specified or preset by the first user as the targets are identified, based on a plurality of payment transaction methods registered in the first electronic wallet. For example, as illustrated in FIG. 3, in Step S101, the “A Pay” and the “B Pay” as the targets are identified from among the three payment transaction methods registered in the first electronic wallet.

The wallet server 10 collects electronic money at a predetermined rate based on the plurality of payment transaction methods identified in Step S101 so that the total amount of the electronic money becomes equal to the planned remittance amount (Step S102). In Step S102, when the electronic money is collected by the “A Pay” and the “B Pay” as illustrated in FIG. 3, the electronic money is collected at the predetermined rate, for example, 8000 yen by the “A Pay” and 2000 yen by the “B Pay” if the planned remittance amount is 10000 yen. The predetermined rate used in Step S102 may be a preset rate, or may be a rate set by the first user every time of remittance.

Furthermore, the wallet server 10 identifies the second electronic wallet associated with the second user as the remittance destination (Step S103). In Step S103, user information corresponding to the second user is identified as the remittance destination specified by the first user, and based on the user information, wallet information about the second electronic wallet is identified. Furthermore, in Step S103, the second user and the second electronic wallet are preset as the remittance destinations from the first electronic wallet, and in the remittance process according to this setting, the second electronic wallet as the remittance destination Is identified.

Then, the wallet server 10 remits electronic money from the first electronic wallet to the second electronic wallet (Step S104). In Step S104, the electronic money in the first electronic wallet as the remittance source is remitted to the second electronic wallet as the remittance destination. In Step S104, in remittance by the “A Pay” and “B Pay” in the first electronic wallet as illustrated in FIG. 3, the remittance process, for example, 8000 yen is remitted by the “A Pay” and 2000 yen is remitted by the “B Pay”, is performed. In addition, a remittance amount of 10000 yen is remitted into the second electronic wallet. The remittance process and deposit process are performed between the wallet server 10 and the payment transaction service provider server 40. After Step S104, this control routine ends.

Note that in the remittance control illustrated in FIG. 4, in Step S103, an account (deposit account) of a financial institution associated with the second user may be identified as the remittance destination. In this case, in Step S104, the remittance is made to the account of the financial institution of the second user.

FIG. 5 is a flowchart illustrating a regular remittance control process. The control illustrated in FIG. 5 is performed by the wallet server 10.

The wallet server 10 determines whether an execution condition for the regular remittance is satisfied (Step S201). In Step S201, when the regular remittance is set for the first electronic wallet, the execution condition for the regular remittance is determined. The wallet server 10 determines whether the regular remittance is set based on the user information and the wallet information stored in the storage unit 13. For example, when remittance of a fixed amount is set on a fixed date every month, it is determined whether the current date is the set date, in Step S201.

If the execution condition for the regular remittance is not satisfied (Step S201: No), the wallet server 10 repeats the processing of Step S201.

If the execution condition for the regular remittance is satisfied (Step S201: Yes), the wallet server 10 collects electronic money at a predetermined rate based on a plurality of payment transaction methods registered in the first electronic wallet so that the amount of the electronic money collected becomes equal to the remittance amount (Step S202). The processing of Step S202 is similar to the processing of Step S102.

Then, the wallet server 10 remits the electronic money to a remittance destination set as a regular remittance destination (Step S203). In Step S203, the electronic money is remitted to at least one of the second electronic wallet and the bank account that are associated with the second user and are the regular remittance destinations. The processing of Step S203 as a remittance method is similar to the processing of Step S104.

Furthermore, the another person as the remittance destination, who is described with reference to FIGS. 4 and 5, may be, for example, a culture lesson teacher who teaches a child, or a family member. In other words, the monthly fee for the culture lesson is remitted to an electronic wallet or bank account associated with the teacher. In remittance between family members, for example, money transfer from a parent to a child is made to an electronic wallet or a bank account that are associated with the child.

Here, the deposit process performed for the first user will be described. For example, when the first user deposits electronic money from a bank account of the first user to an electronic wallet of the first user, the wallet server 10 allocates the deposit of electronic money at a predetermined rate for a plurality of payment transaction methods registered in the electronic wallet.

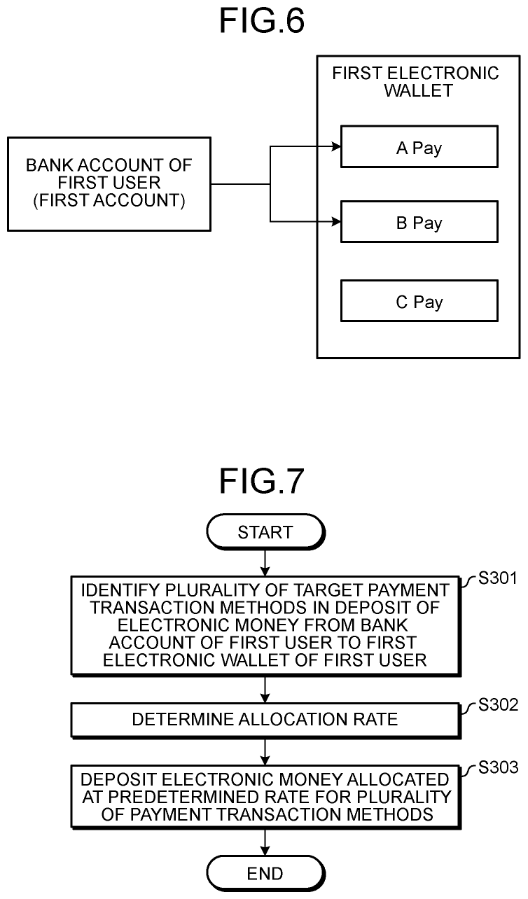

FIG. 6 is a diagram illustrating an example of deposit and allocation in which deposit from the bank account to the electronic wallet is allocated for the plurality of payment transaction methods. As illustrated in FIG. 6, when electronic money is deposited from a first account that is a bank account of the first user into the first electronic wallet that is the electronic wallet of the first user, the deposit of electronic money is allocated at the predetermined rate for the plurality of payment transaction methods. For example, upon deposit of 20000 yen in the bank account into the first electronic wallet, deposit of 20000 yen is allocated at a predetermined rate, for example, 15000 yen for the “A Pay” and 5000 yen for the “B Pay”. The predetermined rate of allocation of deposit may be set by the first user every time of the deposit process or may be preset.

FIG. 7 is a flowchart illustrating a deposit control process. The control illustrated in FIG. 7 is performed by the wallet server 10.

When the first user who is a target for deposit process deposits electronic money in the electronic wallet of the first user from a bank account of the first user, the wallet server 10 identifies a plurality of payment transaction methods that is a deposit target (Step S301). For example, the bank account of the first user is preset as a deposit source to the first electronic wallet, and in the deposit process according to the setting, the first electronic wallet as a deposit destination is identified. Then, in Step S301, for the first electronic wallet associated with the first user, a plurality of payment transaction methods that is the deposit target is identified from among a plurality of different payment transaction methods registered. For example, as illustrated in FIG. 6, in Step S301, the “A Pay” and the “B Pay” as the targets are identified from among the three payment transaction methods registered in the first electronic wallet.

The wallet server 10 determines an allocation rate used for allocation of electronic money for a plurality of payment transaction methods that is the deposit destination (Step S302). The allocation rate represents a ratio. The allocation rate used in Step S302 may be a preset rate, or may be a rate set by the first user every time of deposit. In other words, in Step S302, the allocation rate is identified for the plurality of payment transaction methods that is the deposit target. For example, as illustrated in FIG. 6, upon deposit to the “A Pay” and the “B Pay”, the allocation rate for the “A Pay” and the allocation rate for the “B Pay” are identified.

The wallet server 10 deposits electronic money at the predetermined rate for the plurality of payment transaction methods (Step S303). In Step S303, for example, when a planned deposit amount is 30000 yen and is deposited for the “A Pay” and the “B Pay”, and the allocation rate of the “A Pay” to the “B Pay” is 2:1 as illustrated in FIG. 6, deposit is allocated, for example, 20000 yen for the “A Pay” and 10000 yen for the “B Pay”. This deposit process is performed between the wallet server 10 and the payment transaction service provider server 40. After Step S303, this control routine ends.

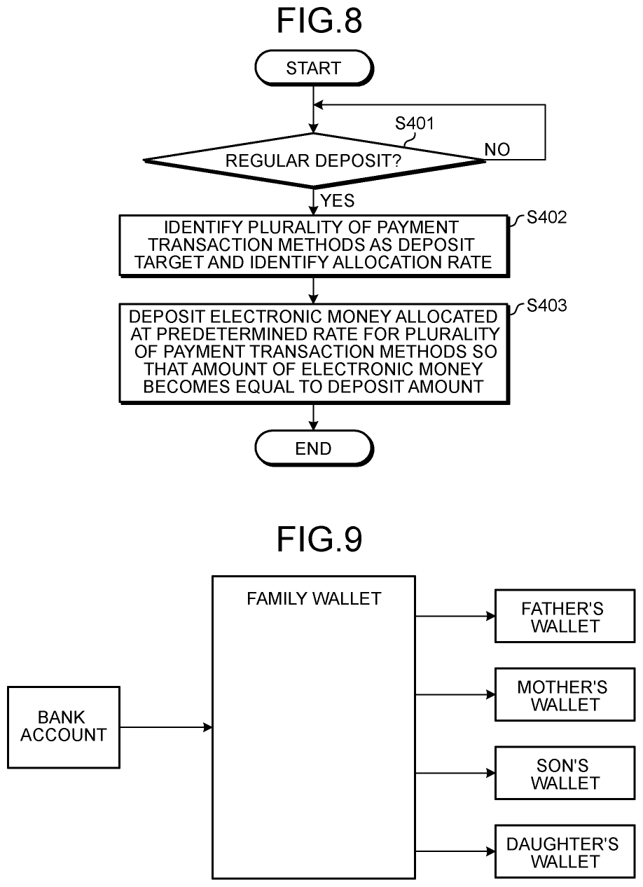

FIG. 8 is a flowchart illustrating a regular deposit control process. The control illustrated in FIG. 8 is performed by the wallet server 10.

The wallet server 10 determines whether an execution condition for the regular deposit is satisfied (Step S401). In Step S401, when the regular deposit into the first electronic wallet is set, the execution condition for the regular deposit is determined. The wallet server 10 determines whether the regular deposit is set based on the user information and the wallet information stored in the storage unit 13. For example, when deposit of a fixed amount is set on a fixed date every month, it is determined whether the current date is the set date, in Step S401.

If the execution condition for the regular deposit is not satisfied (Step S401: No), the wallet server 10 repeats the processing of Step S401.

If the execution condition for the regular deposit is satisfied (Step S401: Yes), the wallet server 10 identifies a plurality of payment transaction methods that is a deposit target and an allocation rate for the payment transaction methods (Step S402). In the processing of Step S402, the process of identifying the plurality of payment transaction methods is similar to that of Step S301, and the process of identifying the allocation rate is similar to that of Step S302.

Then, the wallet server 10 allocates the deposit of electronic money at a predetermined rate for the plurality of payment transaction methods so that the amount of electronic money becomes equal to a deposit amount set for the regular deposit (Step S403). The processing of Step S403 as a deposit method is similar to that of Step S303.

As described above, according to the embodiment, it is possible to increase the degree of freedom in remittance and deposit of electronic money between users.

Note that in the embodiment, the bank account has been described as an example, but the account is not limited to the bank account, as long as the account employs an account of a financial institution.

Furthermore, in the embodiment, the remittance and deposit of electronic money between two users of the first user and the second user has been described, but the wallet system 1 is not limited to this. In other words, it is possible to remit and deposit money between different electronic wallets. For example, the wallet server 10 can manage a shared wallet as an electronic wallet that can be shared by a plurality of users. As an example of the shared wallet, it is possible to provide a family wallet as an electronic wallet that can be shared between family members.

FIG. 9 is a diagram illustrating an example of the family wallet. Note that in the example illustrated in FIG. 9, four users of a father, mother, son, and daughter are assumed as a family structure.

As illustrated in FIG. 9, the family wallet is associated with a father's wallet, mother's wallet, son's wallet, and daughter's wallet. The father's wallet is an electronic wallet associated with the father, the mother's wallet is an electronic wallet associated with the mother, the son's wallet is an electronic wallet associated with the son, and the daughter's wallet is an electronic wallet associated with the daughter. The four users who constitutes this family can use the family wallet.

For example, electronic money deposited in the family wallet from a bank account is configured to be remitted to the father's wallet, mother's wallet, son's wallet, and daughter's wallet. The remittance processes described with reference to FIGS. 3 to 5 can be applied to a remittance process between these electronic wallets. Likewise, the deposit processes described with reference to FIGS. 6 to 8 can be applied to a deposit process from a bank account to the family wallet.

As an example, when the father remits a predetermined amount from the family wallet to the father's wallet, a plurality of target payment transaction methods is determined from among a plurality of different payment transaction methods registered in the father's wallet as a remittance destination, and a predetermined rate is determined. Then, when the electronic money is withdrawn from the family wallet to the father's wallet, a history of the remittance is stored as history information. It is possible for the other family members to browse the history information.

According to the present disclosure, it is possible to increase the degree of freedom in remittance of electronic money between the users.

Although the disclosure has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A wallet server comprising
a processor comprising hardware, the processor being configured to remit electronic money collected at a predetermined rate based on a plurality of payment transaction methods registered in a first electronic wallet associated with a first user, to at least one of a second electronic wallet and a deposit account of a financial institution that are associated with a second user.

2. The wallet server according to claim 1, wherein the processor is configured to remit the electronic money allocated at a predetermined ratio to the second electronic wallet and the deposit account.

3. The wallet server according to claim 2, wherein the processor is configured to allocate the electronic money at a predetermined ratio for a plurality of payment transaction methods registered in the second electronic wallet.

4. The wallet server according to claim 1, wherein the processor is configured to regularly remit electronic money collected at the predetermined rate from the first user to the second user.

5. The wallet server according to claim 4, wherein the processor is configured to:
collect, in regular remittance of the electronic money, the electronic money at the predetermined rate based on the plurality of payment transaction methods in the first electronic wallet so that the amount of the electronic money becomes equal to a preset remittance amount; and
remit the electronic money, the amount of which satisfies the remittance amount, to at least one of the second electronic wallet and the deposit account.

6. The wallet server according to claim 1, wherein the processor is configured to remit the electronic money in response to a remittance request input from a terminal possessed by the first user.

7. The wallet server according to claim 6, wherein the processor is configured to remit the electronic money based on a plurality of payment transaction methods and a rate that are specified by the remittance request.

8. The wallet server according to claim 1, wherein the processor is configured to deposit, in a deposit process from a first account of a financial institution associated with the first user into the first electronic wallet, electronic money allocated at a predetermined rate for a plurality of payment transaction methods registered in the first electronic wallet.

9. The wallet server according to claim 8, wherein the processor is configured to regularly deposit electronic money at a predetermined rate for the plurality of payment transaction methods in the first electronic wallet, from the first account.

10. The wallet server according to claim 9, wherein the processor is configured to deposit, in regular deposit of the electronic money, electronic money at a predetermined rate, for the plurality of payment transaction methods in the first electronic wallet so that the amount of the electronic money becomes equal to a preset deposit amount.

11. The wallet server according to claim 8, wherein the processor is configured to deposit the electronic money, in response to a deposit request input from a terminal possessed by the first user, based on a plurality of payment transaction methods and a rate that are specified by the deposit request.

12. A wallet system comprising:
a terminal comprising a first processor comprising hardware; and
a server comprising a second processor comprising hardware, wherein
the first processor is configured to output a remittance request for remittance of electronic money deposited in a first electronic wallet of a first user to a second user, to the server, and
the second processor is configured to, in response to the remittance request, remit electronic money collected at a predetermined rate based on a plurality of payment transaction methods registered in the first electronic wallet, to at least one of a second electronic wallet and a deposit account of a financial institution that are associated with the second user.

13. The wallet system according to claim 12, wherein
the first processor is configured to output a deposit request for deposit to the first electronic wallet from a first account of a financial institution associated with the first user, to the server, and
the second processor is configured to deposit, in response to the deposit request, electronic money allocated at a predetermined rate for a plurality of payment transaction methods registered in the first electronic wallet.

14. A non-transitory computer-readable recording medium on which an executable program is recorded, the program causing a processor of a computer to execute:
remitting electronic money collected at a predetermined rate based on a plurality of payment transaction methods registered in a first electronic wallet of a first user, to at least one of a second electronic wallet and a deposit account of a financial institution that are associated with a second user.

15. The non-transitory computer-readable recording medium according to claim 14, wherein the program causes the processor to execute remitting, in remittance of electronic money collected at the predetermined rate from the first user to the second user, the electronic money allocated at a predetermined ratio to the second electronic wallet and the deposit account.

16. The non-transitory computer-readable recording medium according to claim 15, wherein the program causes the processor to execute remitting, in remittance of electronic money collected at the predetermined rate from the first user to the second user, the electronic money allocated at a predetermined ratio for a plurality of payment transaction methods registered in the second electronic wallet.

17. The non-transitory computer-readable recording medium according to claim 14, wherein the program causes the processor to execute regularly remitting electronic money collected at the predetermined rate, from the first user to the second user.

18. The non-transitory computer-readable recording medium according to claim 17, wherein the program causes the processor to execute:
collecting, in regular remittance of the electronic money, electronic money at the predetermined rate based on the plurality of payment transaction methods in the first electronic wallet so that the amount of the electronic money becomes equal to a preset remittance amount, and
remitting the electronic money satisfying the remittance amount to at least one of the second electronic wallet and the deposit account.

19. The non-transitory computer-readable recording medium according to claim 14, wherein the program causes the processor to execute depositing, in a deposit process from a first account of a financial institution to the first electronic wallet that are associated with the first user, electronic money at a predetermined rate, for a plurality of payment transaction methods registered in the first electronic wallet.

20. The non-transitory computer-readable recording medium according to claim 19, wherein the program causes the processor to execute regularly depositing electronic money from the first account, for the plurality of payment transaction methods in the first electronic wallet at a predetermined rate.
